(19) United States
(12) Patent Application Publication
(10) Pub. No.: US 2007/0279925 A1
(43) Pub. Date: Dec. 6, 2007

(54) Vehicle Lighting Device

(75) Inventor: Reiner Jocher, Aidlingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, STUTTGART (DE)

(21) Appl. No.: 10/582,359

(22) PCT Filed: Nov. 24, 2004
(86) PCT No.: PCT/EP04/13336

§ 371 Date: Mar. 30, 2007

(30) Foreign Application Priority Data
Dec. 11, 2003 (DE) 103 57 920.6

(51) Int. Cl. F21V 17/02

(52) U.S. Cl. 362/512

(57) ABSTRACT

A vehicle is proposed with a lighting device (7) which has a housing part (9) and a transparent front lens (11) arranged thereon, the housing part (9) being connected in a positionally fixed manner to the vehicle body, and a spring element provided in the connecting region of the lens (11) to the housing part (9). The spring element, when there is an impact effect in the direction of the longitudinal axis of the vehicle, permits the lens (11) to be displaced in the direction of the housing part (9) from a fitted position into a withdrawal position set back in relation to the outer skin of the vehicle. The lighting device (7) is distinguished in that the lens (11) is additionally mounted pivotably about an axis (55) running in the vertical direction to an imaginary horizontal.

### BACKGROUND AND SUMMARY OF THE INVENTION

The invention relates to a vehicle with a lighting device according to the precharacterizing clause of claim 1.

German Patent Document DE 102 11 972 A1 reveals a lighting device for a vehicle having a housing part connected in a positionally fixed manner to the vehicle body and a transparent front lens arranged on said housing part. In order, in the event of an impact of a road user, to keep the risk of injury to him as low as possible, the lens is mounted in a resiliently flexible manner parallel to the longitudinal axis of the vehicle in relation to the housing part, with a spring device used for this purpose being such that, when there is an impact effect in the direction of the longitudinal axis of the vehicle, the spring device permits the lens to be displaced in the direction of the housing part from a fitted position into a withdrawal position set back in relation to the front outer skin of the vehicle and acts upon the lens in the withdrawal position with a force automatically displacing the lens back into its fitted position.

In contrast to lighting devices in which the entire light unit is mounted in a flexible manner, the known lighting device has the advantage that a clearance does not need to be kept behind the lighting device for a possible displacement of the same.

The known lighting device has the disadvantage that, in the case of a corner impact, i.e. if the impact effect on the lens is directed obliquely with respect to the longitudinal center axis of the vehicle, for example in the case of a collision with an obstacle at a steering angle, the lens is not displaced or is displaced only to an inadequate extent in the direction of the housing part because the resulting force acting in the longitudinal center axis of the vehicle is smaller than the spring force of the spring means and/or because the resulting force acting transversely with respect to the longitudinal center axis of the vehicle blocks or retards a displacement of the lens in the direction of the housing part. As a consequence thereof, the lens may break, with the result that, in the event of a collision with a road user, the risk of injury to the latter because of the broken/cracked lens is increased. It has been shown that, in the case of a corner impact, the lens is already damaged at a low impact speed, which makes it necessary to replace the same.

It is the object of the invention to improve a vehicle of the type mentioned at the beginning to the effect that, even in the case of an impact at low speed on a corner region, which has the lighting device, of the vehicle, the force effect acting on the lens is absorbed in such a manner that the risk of damage to the lighting device, in particular the lens, is at least reduced.

To achieve the object, a vehicle is proposed which is distinguished by a lighting device, the lens of which (front lens or dispersion lens and/or covering lens), in addition to its translatory displaceability in the direction of the housing part which is secured on the body, is additionally also mounted pivotably about an axis running in the vertical direction to an imaginary horizontal. In the case of an impact effect, which is directed obliquely to the longitudinal center axis of the vehicle, on the lens, for example in the case of a collision of a vehicle, which has the lighting device, with an object, the lens can pivot about this axis and can therefore yield. As a result, damage to the lens can be avoided at least at low impact speeds.

The spring device is preferably designed in such a manner that it acts upon the lens in the withdrawal position with a force automatically displacing the lens back into its fitted position.

In a preferred embodiment, it is provided that the lens is acted upon by a spring means with a force such that, after the external force effect leading to a pivoting of the lens is removed, said the lens is automatically displaced back into its fitted position. According to a first variant embodiment, it is provided that this spring device is the same means which also serves for the translatory resetting of the lens from its withdrawal position into its fitted position. As an alternative, it can be provided that separate spring means are provided in each case for the translatory movement and the resetting, taking place by pivoting, of the lens into its fitted position.

An exemplary embodiment of the lighting device is particularly preferred, in which the mounting of the lens is designed in such a manner that, depending on the point of application, direction of action and size of an impact acting on the lens, the lens executes only a pivoting movement, only a translatory movement or a combination of both types of movement. The pivot bearing of the lens can therefore be displaced along an exact guide path, or guide path predetermined at least within certain limits, which can run linearly, in particular parallel to the longitudinal center axis of the vehicle, or in a curved manner. As a result, a greatest possible flexibility of the lens or of the mounting thereof is provided while it is, at the same time, sufficiently precisely guided and connected to the housing part, thus making it possible both in the case of a force effect directed parallel to the longitudinal center axis of the vehicle (angle α=0°) and in the case of a force effect directly obliquely thereto (α greater than 0°, preferably in the range between 0° and 45°, in particular in the range between 0° and 30°) to avoid damage to the lens or the housing part arranged behind it at at least low impact speeds, in particular lower than 20 kmh.

Furthermore, an exemplary embodiment is preferred in which the pivot bearing of the lens is provided on that side edge of the lens which is situated closer to the center of the vehicle. This ensures that the lens as it were dips into a position set back in relation to the outer skin of the body and that, in the process, no region of the lens protrudes beyond the outer skin of the body.

According to a development of the invention, it is provided that the pivot bearing is formed by at least one pivot pin which is provided on the lens and is supported on a guide rail. The pivot pin may be integrally formed on the lens, which is composed of glass or plastic. The guide rail serves in this case as a sliding bearing for the pivot pin during a translatory movement of the lens in the direction of the set-back housing part. The guide rail may be of straight or curved design and is preferably fastened to the housing part or formed thereon.

An exemplary embodiment is also particularly preferred in which the mounting of the lens, which mounting is resiliently flexible with respect to the housing part, by means of the spring means is designed as a multi-point mounting. The spot-type, resilient connection of the lens to the housing part affords advantages during the pivoting of the lens as a consequence of an impact effect. In this case, at least one of the fastening points has a spring element which, at its one end, is fixed on the body and, at its distal end, the connecting region to the lens is provided. All of the fastening points are preferably of identical design, thus reducing the multiplicity of variants. The spring element is preferably designed in such a manner that it permits a translatory displacement and a pivoting movement of the lens about its pivot axis and, in the process, acts upon said lens with a force displacing it back into its fitted position.

The housing part may be produced, for example, by means of diecasting. In this case, the fastening points of the lens may be integrated in the diecast housing, preferably formed thereon.

In a preferred embodiment, the spring element is designed as a coil, the coil—differently than a helical spring—tapering in the direction of its end fixed on the body. Owing to the tapering of the coil, the latter can correspondingly bend during the pivoting of the lens and can additionally also be correspondingly compressed during a superimposed translatory displacement of the lens in the direction of the housing part.

The configuration of the spring element is not restricted to the exemplary embodiment described above. In principle, an element composed of elastic material, for example rubber or foam, may also be used as spring element. It is important that the spring element is designed such that it can be compressed and bent, so that, when there is an impact effect, the lens can be displaced both pivotably and in the direction of the housing part counter to the spring force applied by means of the spring element.

Furthermore, an exemplary embodiment of the lighting device is preferred in which means for adjusting the lens with respect to the outer skin of the vehicle are provided. The adjusting means are preferably designed in such a manner that, in addition to their actual function of aligning the lens with respect to the outer skin of the vehicle in a positionally precise manner, they also serve as means for holding the lens on the housing part. A simple and cost-effective construction of the lighting device can therefore be realized.

Finally, an exemplary embodiment of the lighting device is also preferred which is distinguished in that the housing part, the lens and the spring means form a preassembleable construction unit. The lighting unit can therefore be constructed as a whole together with the vehicle, which simplifies the installation of said lighting device.

Further important features and advantages of the invention emerge from the subclaims, from the drawing and from the associated descriptions of the figures with reference to the drawing.

It goes without saying that the features mentioned above and those which have yet to be explained below can be used not only in the respectively stated combination but also in other combinations or on their own without departing from the scope of the present invention.

A preferred exemplary embodiment of the invention is illustrated in the figures and is explained in more detail in the description below, with the same reference numbers referring to identical or similar or functionally identical components.

### BRIEF DESCRIPTION OF THE DRAWINGS

FIG. 1 shows, in a diagrammatic illustration, a longitudinal section through a front end section of a motor vehicle in the region of a lighting device along an intersecting line B-B indicated in FIG. 2;

FIG. 2 shows a cutout of the motor vehicle according to FIG. 1 in the viewing direction of the front end section;and

FIG. 3 shows a cutout of the lighting device in the sectional illustration according to the intersecting line A-A indicated in FIG. 2.

### DETAILED DESCRIPTION OF THE DRAWINGS

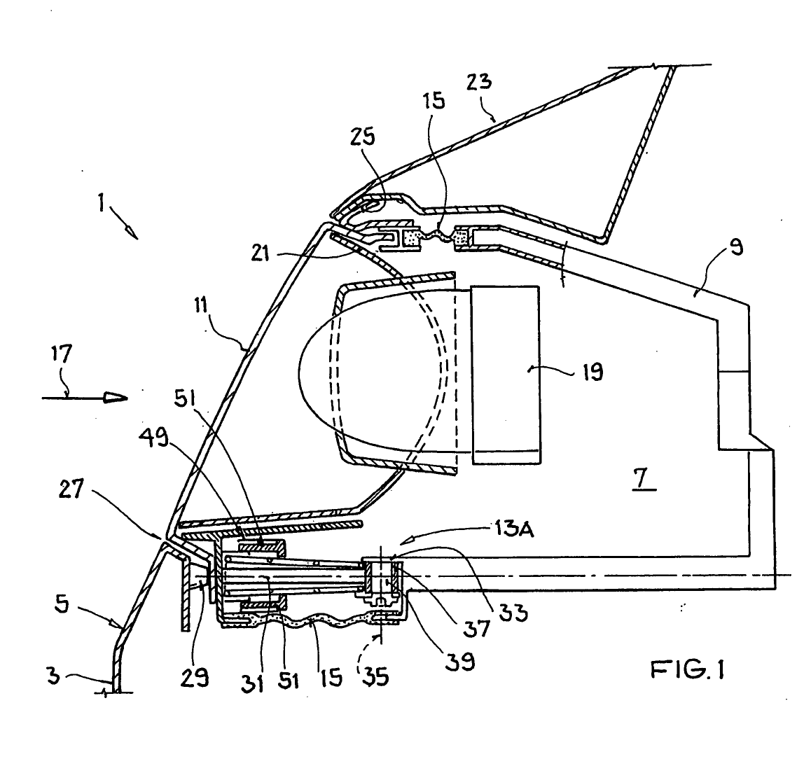

FIG. 1 shows a front end section of a motor vehicle (otherwise not illustrated specifically) which comprises a bumper outer skin 3, which forms part of a bumper arrangement 5, and a lighting device 7.

The lighting device 7 includes a housing part 9 which is attached in a positionally fixed manner to a body (not illustrated in FIG. 1) and is closed on the front end side by a dispersion and/or covering lens 11, called lens for short below. The lens 11 is mounted moveably on the housing part 9 by means of a multi-point mounting, it only being possible, in the illustration according to FIG. 1, to see one of the fastening points, namely the fastening point 13A which is situated in a lateral, outer edge region of the lens 11 and of the housing part 9.

At the transitions between the housing part 9 and the lens 11 there are arranged elastic seals 15 which permit a displacement of the lens 11 relative to the housing part 9 in an essentially horizontal impact direction 17 running parallel to the longitudinal axis of the vehicle, and at the same time seal off an interior space of the lighting device 7 with respect to the external environment, so that said interior space is protected from moisture and/or dirt.

A light unit 19 which radiates light to the outside through the lens 11 counter to the impact direction 17 is integrated in the lighting device 7. A design panel 21 can also be seen.

As illustrated in FIG. 1, an outer contour of the front end section 1 is shown by an outline which is determined by the bumper outer skin 3, the lens 11 and an engine hood 23. The engine hood 23 adjoins an upper region of the lens 11. A further seal 25 is expediently provided between the lens 11 and the engine hood 23.

As is apparent from FIG. 1, in the case of this exemplary embodiment the bumper outer skin 3 is separated from the lens 11 by a gap 27 which can be designed such that it differs in width depending in each case on the desired external appearance, as a result of which it is possible to influence the external appearance or the design of the vehicle. A supporting element 29 is arranged between the lens 11 and the bumper arrangement 5, said supporting element, in the event of a crash, transmitting the force acting in the impact direction 17 from the bumper arrangement 5 to the lens 11. In an advantageous manner, a supporting element 29 is arranged in each case as an extension of the lower fastening points 13A, 13B of the lens 11, so that, in the event of a crash, said supporting elements introduce the forces centrally into the fastening points 13A and 13B.

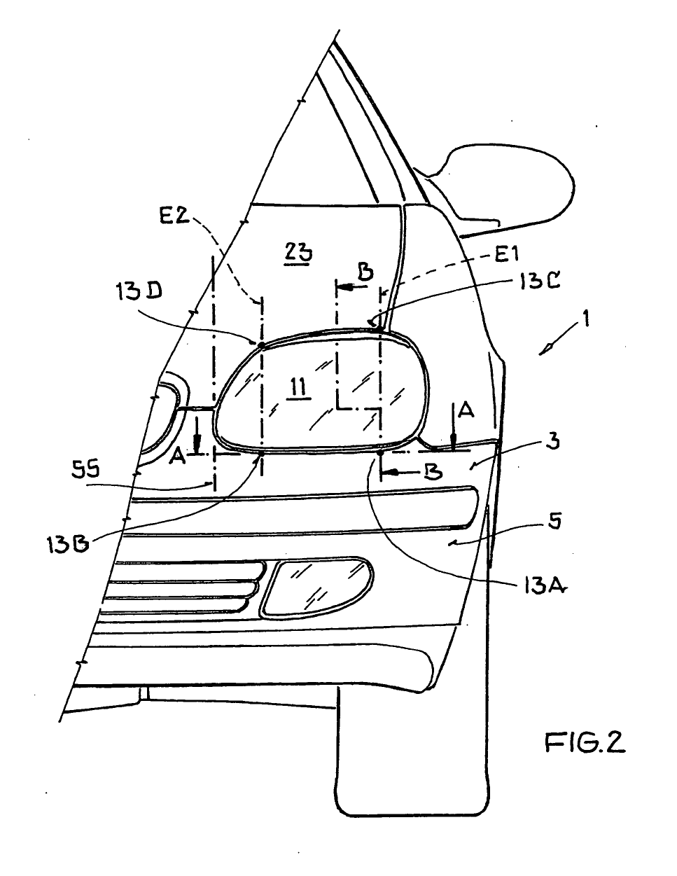

In the case of this exemplary embodiment of the lighting device 7, the lens 11 is connected to the housing part 9 by means of a total of four fastening points 13, with the fastening points 13A and 13B provided on the lower edge region of the lens 11 being situated approximately at the same height in the horizontal direction while the fastening points 13C and 13D provided on the upper edge region are at an offset with respect to each other in the vertical direction, as is apparent from FIG. 2. In this case, the fastening points 13A and 13C are situated in an imaginary plane 1 running in the vertical direction and the fastening points 13B and 13D are situated in a plane E2 arranged parallel thereto. The number and arrangement of the fastening points is not restricted to the exemplary embodiment described above but rather, in the case of other lighting devices with a larger or smaller lens, can be correspondingly adapted.

In the case of this exemplary embodiment, the fastening points 13A to 13D are of identical design, and so their construction is explained in more detail below with reference to the fastening point 13A by way of example.

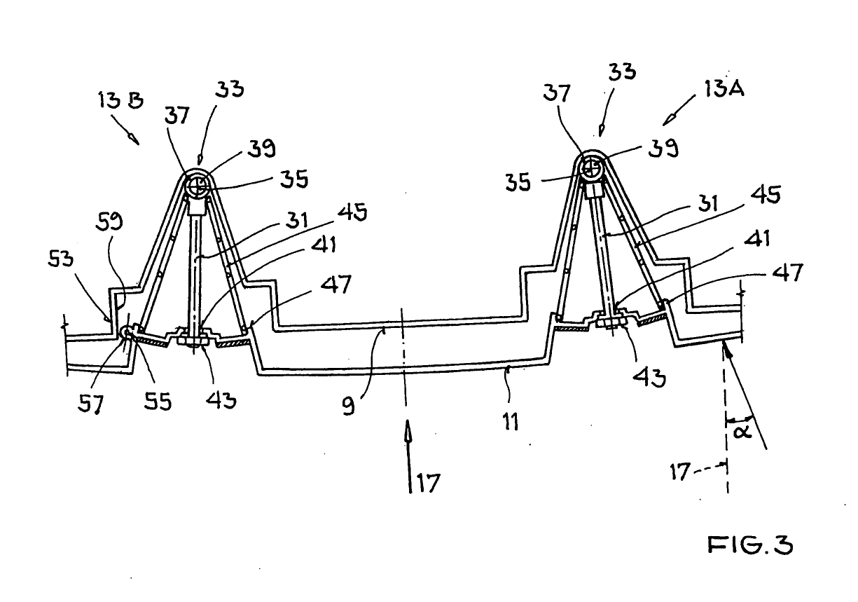

The fastening point 13A comprises a rod-shaped coupling member 31 which can be pivoted at its one end by means of a pivot bearing 33 about an axis 35 running perpendicularly with respect to the longitudinal center axis of the coupling member 31. The pivot axis 35 runs essentially perpendicularly to an imaginary horizontal. The pivot bearing 33 is formed here by a bushing-shaped element 37 connected to the coupling member 31 and a bearing journal 39 engaging in the element 37. The bushing-shaped element 37 is held in a positionally fixed manner in a receptacle in the housing part 9, as indicated in FIG. 1. The coupling member 31 reaches with its distal, free end through a passage opening 41, which can be seen in FIG. 3, in the lens 11 with play. This end of the coupling member 31 is provided with an external thread onto which a head element 43 is screwed from the front side of the lens 11, as a result of which the lens 11 is connected captively to the coupling member 31 and therefore to the housing part 9.

As is apparent from FIGS. 1 and 3, a spring element 45, which is only illustrated diagrammatically, is provided between the housing part 9 and the lens 11. The spring element 45 is clamped between the element 37 and the lens 11 and serves for the resiliently flexible mounting of the lens 11 with respect to the housing part 9. The spring element 45 is designed as a coil which—as seen in the plan view of the spring element 45 (FIG. 3)—in contrast to the one helical spring, tapers in the direction of its end facing away from the lens 11 and the height of which—as seen in the side view of the spring element 45 (FIG. 1)—decreases. In the case of this exemplary embodiment, the coil has an essentially rectangular cross section. As is apparent from FIG. 3, the spring element 45 engages with its end of larger diameter in a surround 47 which is integrally formed on the lens 11 and prevents a lateral displacement of the spring element 45 relative to the lens 11. It remains to be stated that, in the figures, of the spring element 45 overall only the outline is illustrated and indicated and, on account of its complex geometry, a detailed illustration has been omitted for reasons of clarity.

The fastening point 13A described above is designed in such a manner that, when there is an impact effect in the direction of the longitudinal axis of the vehicle or parallel thereto, for example in the case of a frontal impact (impact direction 17) against an obstacle counter to the force of the spring element 45, with the latter being compressed, the lens 11 is displaced in the direction of the housing part 9 from a fitted position (illustrated in FIG. 1) into a withdrawal position (not illustrated) set back in relation to the outer skin of the vehicle and, when the impact effect by means of the spring element 45 is removed, is automatically displaced back into its fitted position secured by means of the head element 43. In the case of a frontal impact, the point of application of force and region of application of the impact effect on the lens 11 frequently lie in the central region of the same.

The spring element 45 is preferably prestressed, with it being possible for the prestress to be set by means of the head element 43. In addition, the position of the lens 11 relative to the housing part 9 and therefore to the body, in particular the outer skin of the body, can be set exactly by means of the head element 43 by the head element 43 being screwed a corresponding distance onto the coupling member 31. The coupling member 31, the head part 43 and the spring element 45 therefore form adjusting means for aligning the lens 11 with respect to the outer skin of the vehicle and securing the lens 11 in its fitted position. The above described configuration of the connection of the lens 11 to the housing part 9 makes it possible to entirely assemble the lighting device 7 in a pre-installation step and to fit it as a unit on the vehicle, for which purpose only the housing part 9 has to be fastened to the vehicle body. The lens 11 can then subsequently be brought into its fitted position by means of adjustment of the head elements 43 provided on the fastening points 13A to 13D, i.e. can be aligned in relation to the engine hood 23 and the bumper outer skin 2. This adjustment/alignment of the lens 11 is possible in a simple manner by one person on account of the accessibility of the head elements 43 from the front side of the lens 11.

So that the spring element 45 cannot yield/buckle perpendicularly with respect to its predetermined direction of deformation as it is being compressed, in the case of the exemplary embodiment illustrated in the figures a guide device 49, which can be seen in FIG. 1, is provided comprising guide rails 51 which are provided above and below the spring element 45 and which can be formed, for example, on the limbs of a U-shaped profile.

It also remains to be stated that the supporting element 29 is arranged here as an extension of the longitudinal center axis of the coupling member 31, with the result that, in the event of a crash, the forces transmitted by the bumper arrangement 5 to the lens 11 are introduced directly into the pivot bearing 33. Such a supporting element 29 is preferably provided on each of the lower fastening points 13A and 13B and, apart from that, the bumper arrangement 5 without contact with the lens 11.

The lens 11 is not only mounted in a resiliently flexible manner parallel to the longitudinal center axis of the vehicle with respect to the housing part 9 but also pivotably. For this purpose, a pivot bearing 53, which can be seen in FIG. 3, is provided, in the case of this exemplary embodiment, on that side edge of the lens 11 which is situated closer to the center of the vehicle, the pivot bearing being designed in such a manner that the lens 11 can be pivoted about an axis 55 running in the vertical direction to an imaginary horizontal in order, in the event of a corner impact directed obliquely with respect to the longitudinal center axis of the vehicle, to pivot away in the direction of the housing part 9 so as to avoid damage to the lens 11 or, in the event of an impact of a person, to reduce the risk of injury thereto. In FIG. 3, the pivot axis 55 runs perpendicularly with respect to the plane of the picture.

In the case of the exemplary embodiment, described with reference to the figures, of the lighting device 7, the pivot bearing 53 is formed by a pivot pin 57 which is integrally formed on the lens 11, bears against a guide rail 59, which is arranged in a positionally fixed manner with respect to the body, and is guided by said guide rail. The guide rail 59 is aligned with respect to the longitudinal axis of the vehicle in such a manner that, when there is an impact effect, which is directed essentially parallel to the longitudinal axis of the vehicle, on the lens 11, the latter is displaced along the guide rail 59 in the direction of the housing part 9. The guide rail 59 therefore expediently runs essentially parallel to the longitudinal axis of the vehicle. In this connection, the term “essentially parallel” is therefore understood as also meaning deviations of some angular degrees.

Of course, it is also possible to arrange the guide rail 59 with respect to the longitudinal center axis of the vehicle in such a manner that they enclose an angle with each other which is, for example, in a range of greater than 0° to 30°. This variant embodiment may be required in certain designs of vehicle.

When there is an impact effect on the lens 11 in its side region near the vehicle, as may occur, for example, in the case of a collision with an obstacle during cornering, within a certain angular range α indicated in FIG. 3, the lens 11 is pivoted about the axis 55 in the direction of the housing part 9. The spring elements 45 in the region of the fastening points 13 are in this case deformed to different extents on account of their different distances from the pivot axis 55. The spring elements 45 at greater distance from the pivot axis 55 are more severely deformed than the spring elements 45 near the pivot axis. During the pivoting of the lens 11, the coupling members 31 are also pivoted about the respective axis 35 by a certain amount dependent on the degree of deformation of the respective assigned spring element 45. So that the lens 11 is not damaged in the process, the passage openings 41 are to be selected to be of a corresponding size in order to permit a movement of the lens 11 relative to the coupling member 31 not only in the direction of the longitudinal center axis of the coupling member 31 but also in the vertical direction.

The above described, resiliently flexible mounting of the lens 11 makes it possible, depending on the point of application, direction of action and size of an impact acting on the lens 11, for the lens 11 to execute only a pivoting movement about the axis 55, only a translatory movement along the guide rail 59 or a combined pivoting and translation movement.

The impact angle α, i.e. the direction in which the impact acting on the lens 11 is directed with regard to the outer skin of the vehicle, can lie in a range between 0° (parallel to the longitudinal center axis of the vehicle) and 30° or above (see FIG. 3). Within this angular range, in the event of a collision, at low vehicle speeds damage to the lens 11 can be prevented both in the case of a frontal impact of an obstacle and in the case of a corner impact.

From all of the above, it is clear that the coupling member 31 also fulfills the function of a guide element which permits a relative displacement of the lens 11 in the impact direction 17 or in a direction, situated within the angular range α, of the housing part 9. After an impact effect with deflection in the impact direction, the spring elements 45 press the lens 11, if appropriate together with the bumper outer skin 3, which is coupled to the lens 11 via the supporting elements 29, automatically back into a normal starting position (fitted position).

The system described with reference to the figures is intended in particular to serve, in the event of a crash, to reduce the damage to the vehicle and at the same time, in the case of a collision with a person, to reduce the injury consequences for him. In the event of an impact of a pedestrian in the impact direction 17 (frontal impact) on the front end region, first of all the bumper outer skin 3 is deformed. When a predetermined force is exceeded, the bumper outer skin 3 together with the lens 11 connected thereto moves in the impact direction 17 towards the housing part 9 and therefore provides an additional deformation distance. As described above, in the event of a corner impact, the lens 11 yields in the direction of the housing part 9 by pivoting about the axis 55.

The lens 11 is preferably produced from transparent plastic (polycarbonate) and therefore, like the bumper outer skin 3, has an impact-damping effect. As a result, in contrast to a lens 11 made in glass, at higher impact speeds a cracking of the same, as would be the case if it were made of glass, is avoided, thus making it possible to reduce the risk of injury to the pedestrian.

In summary, the essential features of the solution according to the invention can be characterized as follows:

the lighting device 7 essentially comprises the housing part 9, which is connected fixedly to the body (not illustrated), and the lens 11 which can optionally also be integrated in a front housing part and which, for its part, is held on the housing part in a resiliently flexible manner by means of the fastening points 13. The lens 11 is formed from transparent plastic (polycarbonate) and, in the event of a crash, tends not to form injury-promoting splinters. In the event of a collision of the motor vehicle with a pedestrian and an impact of the same in the impact direction 17 on the front end section 1 of the motor vehicle, first of all the bumper outer skin 3 is deformed and, when a certain force effect is exceeded, the lens 11 together with the bumper outer skin 3 is displaced along the guide rail 59 in the direction of the housing part 9 counter to the force of the spring means (spring elements 45) and—depending on the position of the point of application of the force acting on the lens 11—is additionally or alternatively pivoted about the axis 55 in the direction of the housing part 9 counter to the spring force.

It also remains to be stated that the number of above-described fastening points 13 of the lens 11 on the housing part 9 is not restricted to four. On the contrary, under some circumstances also fewer than four fastening points may be sufficient or more than four fastening points may be required. The arrangement of the fastening points relative to one another is also not restricted to the exemplary embodiment described with reference to the figures. The fastening points arranged in each case on a side edge of the lens 11 may, but do not have to be, arranged at the same height in the viewing direction of an imaginary horizontal. Also, the fastening points provided on the opposite lens side edges do not absolutely have to be positioned in alignment—as seen in the vertical direction.

The lighting device 7 according to the invention can be designed as a head light, which is arranged on the front end section of the vehicle, or else as a rear light unit arranged on the rear section of the vehicle.

The spring element 45 described with reference to the figures has overall a triangular basic body, the tip of which points in the direction of the housing part 9 or the vehicle body. As an alternative to the configuration as a funnel-shaped coil having an essentially rectangular cross section, the spring element 45 may also be formed from a rubber part or foam part. It is important for the functioning of the spring element 45, which serves as an energy-absorbing part, that, during the pivoting of the lens about the axis 55, said spring element realizes the degrees of deformation which partially differ as a consequence of the differently sized distances of the individual regions from the pivot axis 55. Furthermore, the triangular basic shape of the spring element 45 has the advantage that the bearing contact surface against the lens 11 is relatively large and therefore the support is correspondingly good.

Part of the housing part 9 is illustrated in FIG. 3. It can be seen that the guide rail 59 is formed as a single piece thereon and, on its end region, forms a stop for the lens. According to a first variant embodiment, the housing part 9, which is composed, for example, of plastic, can be fastened directly to the vehicle body or, according to another variant embodiment, to a diecast housing part attached to the body. It remains to state that the housing part 9, the lens and the means for the resilient mounting of the lens on the housing part form a modular construction unit.

1.-21. (canceled)

22. A vehicle lighting device comprising:
a housing part and a transparent front lens arranged thereon, the housing part being connected in a positionally fixed manner to the vehicle body;
a spring device provided in a region connecting the lens to the housing part, wherein the spring device, when there is an impact effect in the direction of the longitudinal axis of the vehicle, permits the lens to be displaced in the direction of the housing part from a fitted position into a withdrawal position offset back in relation to an outer skin of vehicle into which said lighting device is fit, wherein the lens is mounted pivotably about an axis running in a direction in order to pivot the lens in a direction toward the housing part when said vehicle is subject to a corner impact obliquely with respect to said longitudinal axis of the vehicle.

23. The vehicle lighting device as claimed in claim 22, wherein a mounting of the lens is designed in such a manner that, depending on the point of application, direction of action and size of an impact acting on the lens, the lens executes only a pivoting movement, only a translatory movement or a combination of both types of movement.

24. The vehicle lighting device as claimed in claim 22, wherein a pivot bearing of the lens is provided on a side edge of the lens which is situated closer to the center of the vehicle.

25. The vehicle lighting device as claimed in claim 24, wherein the pivot bearing is formed by at least one pivot pin which is provided on the lens (11) and is supported on a guide rail.

26. The vehicle lighting device as claimed in claim 25, wherein the guide rail is aligned with respect to the longitudinal center axis of the vehicle in such a manner that, when there is an impact effect on the lens within a certain angular range, the lens is displaced along the guide rail in the direction of the housing part.

27. The vehicle lighting device as claimed in claim 22, wherein a resiliently flexible mounting of the lens on the housing part by means of the spring device is designed as a multi-point mounting.

28. The vehicle lighting device as claimed in claim 27, further including a plurality of fastening points with at least one of said fastening points including a spring element which, at its one end on the vehicle body side, is arranged in an essentially positionally fixed manner and, at its distal end, the connecting region to the lens is provided.

29. The vehicle lighting device as claimed in claim 28, wherein the spring element is designed as a coil.

30. The vehicle lighting device as claimed in claim 29, wherein the coil tapers in the direction of an end facing away from the lens.

31. The vehicle lighting device as claimed in claim 29, wherein the height of the coil decreases in the direction of an end facing away from the lens.

32. The vehicle lighting device as claimed in claim 29, wherein the coil has an essentially rectangular cross section.

33. The vehicle lighting device as claimed in claim 12, further including a device for adjusting the lens with respect to an outer skin of the vehicle.

34. The vehicle lighting device as claimed in claim 33, wherein the adjusting device additionally couples the lens and housing part.

35. The vehicle lighting device as claimed in claim 33, wherein the adjusting device is arranged on fastening points of the lens or is integrated in the fastening points.

36. The vehicle lighting device as claimed in claim 35, wherein at each of the fastening points a respective coupling membrane is provided, the coupling membrane reaching through the spring element and at one end a pivotably mounted element is provided and another end reaches through a passage opening in the lens with play.

37. The vehicle lighting device as claimed in claim 36, wherein the end reaching through the passage opening is provided with an external thread onto which a head element provided with an internal thread can be screwed from the front side of the lens.

38. The vehicle lighting device as claimed in claim 35, wherein the fastening points for the lens are provided on the housing part.

39. The vehicle lighting device as claimed in claim 22, wherein the housing part, the lens and the spring device form a preassembleable construction unit.

40. The vehicle lighting device as claimed in claim 22, wherein at least one fastening point for fastening the lens to the housing part is provided in an upper and lower edge region of the lens.

41. The vehicle lighting device as claimed in claim 35, wherein the pivot bearing, a plurality of fastening points and the guide rail are formed integrally on the housing part.
